(19) United States
(12) Patent Application Publication
(10) Pub. No.: US 2024/0181906 A1
(43) Pub. Date: Jun. 6, 2024

(54) CHARGING CONTROL PILOT CIRCUIT AND CHARGING SOCKET

(71) Applicant: CHANGCHUN JETTY AUTOMOTIVE PARTS CORPORATION, Changchun, Jilin (CN)

(72) Inventor: Chao WANG, Changchun, Jilin (CN)

(73) Assignee: Changchun Jetty Automotive Technology Co., Ltd., Changchun, Jilin (CN)

(21) Appl. No.: 18/549,847

(22) PCT Filed: Oct. 11, 2021
(86) PCT No.: PCT/CN2021/123058

§ 371 Date: Sep. 8, 2023

(30) Foreign Application Priority Data
Mar. 19, 2021 (CN) 202120567464.6

(51) Int. Cl. B60L 53/16; B60L 53/22

(52) U.S. Cl. CPC B60L 53/16; B60L 53/22

(57) ABSTRACT

A charging control pilot circuit includes: a lead group including a first lead, a second lead and a third lead, in which one end of the first lead, one end of the second lead and one end of the third lead are respectively electrically connected to a connection line of an external charging device; a first loop including two or more resistors corresponding to the type of the external charging device, in which the first loop is disposed between the other end of the first lead and the other end of the third lead and electrically connected to the first lead and the third lead; and a second loop disposed between the other end of the second lead and the other end of the third lead and electrically connected to the second lead and the third lead.

### CROSS-REFERENCE TO RELATED APPLICATIONS

This application is a National Stage of International Application No. PCT/CN2021/123058, filed Oct. 11, 2021, which claims priority to Chinese Utility Model Patent Application No. 202120567464.6, filed on Mar. 19, 2021, entitled ‘charging control pilot circuit and a charging socket’, both of which are hereby incorporated by reference in their entireties.

### TECHNICAL FIELD

The embodiments of the present disclosure relate to the technical field of electric vehicle charging, and particularly to a charging control pilot circuit and a charging socket.

### BACKGROUND

In order to solve the increasingly prominent problems of energy crisis and environmental pollution, new energy vehicles have become the main development strategy in various countries. For example, as a kind of new energy vehicles, electric vehicles driven by electric energy have been widely developed.

The solution of charging technology for electric vehicles is an important issue in the field of electric vehicles. At present, the international mainstream charging systems include a CHAdeMO charging system, a GB2015 charging system and a CCS charging system. In addition, a ChaoJi charging system is also proposed in China.

It should be noted that the above introduction to the technical background is only for the convenience for clear and complete explanations of the technical solutions of the present disclosure and facilitate the understanding by those skilled in the art. The above technical solutions cannot be considered to be well known to those skilled in the art merely because they have been described in the background section of the present disclosure.

### SUMMARY

The inventor finds that the existing electric vehicles cannot be forwardly compatible with a plurality of charging systems for communication protocols, interface physical forms, connection circuits, etc. of different charging systems, so cannot meet the demand of the current charging market.

In order to solve at least one of the above technical problems, the embodiments of the present disclosure provide a charging control pilot circuit and a charging socket, which can enable the electric vehicles to be forwardly compatible with a plurality of charging systems and meet the demand of the current charging market.

According to a first aspect of the embodiments of the present disclosure, there is provided a charging control pilot circuit, including: a lead group including a first lead, a second lead and a third lead, and one end of the first lead, one end of the second lead and one end of the third lead are respectively electrically connected to a connection line of an external charging device; a first loop including two or more resistors corresponding to the type of the external charging device, and the first loop is disposed between the other end of the first lead and the other end of the third lead and electrically connected to the first lead and the third lead; and a second loop disposed between the other end of the second lead and the other end of the third lead and electrically connected to the second lead and the third lead.

According to a second aspect of the embodiments of the present disclosure, in which the first loop includes a first branch, and the first branch includes a first resistor, a second resistor, a third resistor and a single-pole four-throw switch, and a moving contact of the single-pole four-throw switch is connected to the other end of the first lead, and four static contacts of the single-pole four-throw switch are respectively suspended and connected to the first resistor, the second resistor and the third resistor, and the first resistor, the second resistor and the third resistor are connected to the other end of the third lead.

According to a third aspect of the embodiments of the present disclosure, in which resistance values of the first resistor, the second resistor and the third resistor are respectively greater than 0 and less than or equal to 100 MΩ.

According to a fourth aspect of the embodiments of the present disclosure, in which the first loop further includes a second branch, which is connected in parallel with the first branch and includes a first switch and a fourth resistor connected in series.

According to a fifth aspect of the embodiments of the present disclosure, in which an initial state of the first switch is normally open.

According to a sixth aspect of the embodiments of the present disclosure, in which an initial state of the first switch is normally closed.

According to a seventh aspect of the embodiments of the present disclosure, in which the first loop further includes a third branch, which is connected in parallel with the first branch and includes a fifth resistor.

According to an eighth aspect of the embodiments of the present disclosure, in which the first loop further includes a diode, a cathode of which is connected to the moving contact of the single-pole four-throw switch, and an anode of which is connected to the other end of the first lead.

According to a ninth aspect of the embodiments of the present disclosure, in which an initial state of the single-pole four-throw switch is normally open.

According to a tenth aspect of the embodiments of the present disclosure, in which an initial state of the single-pole four-throw switch is normally closed.

According to an eleventh aspect of the embodiments of the present disclosure, in which the second loop includes a second switch, a sixth resistor, a power supply, a third switch and a seventh resistor, and the second switch, the sixth resistor and the power supply are connected in series, and the sixth resistor is connected in parallel with the seventh resistor and the third switch.

According to a twelfth aspect of the embodiments of the present disclosure, in which initial states of the second switch and the third switch are normally open.

According to a thirteenth aspect of the embodiments of the present disclosure, in which initial states of the second switch and the third switch are normally closed.

According to a fourteenth aspect of the embodiments of the present disclosure, there is provided a charging socket, including the charging control pilot circuit according to any one of the first aspect to the thirteenth aspect of the embodiments of the present disclosure.

One of the advantageous effects of the embodiments of the present disclosure is that by disposing a plurality of resistors corresponding to the type of the charging device in the charging control pilot circuit, the electric vehicle may be forwardly compatible with a plurality of charging systems, and meet the demand of the current charging market.

With reference to the following description and drawings, the particular embodiments of the present disclosure are disclosed in detail, to point out the ways in which the principles of the present disclosure can be adopted. It should be understood that the embodiments of the present disclosure are not limited in scope thereby. The embodiments of the present disclosure include many changes, modifications and equivalents within the scope of the clauses of the appended claims.

Features described and/or illustrated for one embodiment may be used in one or more other embodiments in the same or similar ways, and may be combined with or substitute for features in other embodiments.

It should be emphasized that the term ‘comprise/include’ when used herein refers to the presence of features, integers, steps or components, but does not exclude the presence or addition of one or more other features, integers, steps or components.

### BRIEF DESCRIPTION OF THE DRAWINGS

Elements and features described in one drawing or implementation of the embodiments of the present disclosure may be combined with elements and features illustrated in one or more other drawings or implementations. Further, in the drawings, similar reference numerals denote corresponding parts in several drawings, and may be used to indicate corresponding parts used in more than one implementation.

The drawings, which are included to provide further understanding of the embodiments of the present disclosure, constitute a part of the specification to illustrate the embodiments of the present disclosure, and together with the description, to explain the principles of the present disclosure. It should be apparent that the drawings in the following description only illustrate some embodiments of the present disclosure, and those of ordinary skill in the art may obtain other drawings therefrom without any creative labor. In the drawings:

FIG. 1 is a schematic diagram of a charging control pilot circuit according to an embodiment of a first aspect of the present disclosure;

FIG. 2 is a schematic diagram of a connection between a charging control pilot circuit and a CCS1 charging device according to an embodiment of a first aspect of the present disclosure;

FIG. 3 is a schematic diagram of a connection between a charging control pilot circuit and a CCS2 charging device according to an embodiment of a first aspect of the present disclosure;

FIG. 4 is a schematic diagram of a connection between a charging control pilot circuit and a CHAdeMO charging device according to an embodiment of a first aspect of the present disclosure;

FIG. 5 is a schematic diagram of a connection between a charging control pilot circuit and a GB2015 charging device according to an embodiment of a first aspect of the present disclosure; and

FIG. 6 is a schematic diagram of a connection between a charging control pilot circuit and a ChaoJi charging device according to an embodiment of a first aspect of the present disclosure.

### DETAILED DESCRIPTION

The foregoing and other features of the present disclosure will become apparent from the following specification with reference to the drawings. In the specification and drawings, particular embodiments of the present disclosure are specifically disclosed, which illustrate some embodiments in which the principles of the present disclosure may be adopted. It should be understood that the present disclosure is not limited to the described embodiments. On the contrary, the present disclosure includes all modifications, variations and equivalents falling within the scope of the appended claims. Various embodiments of the present disclosure will be described below with reference to the drawings. These embodiments are only exemplary, rather than limitations to the present disclosure.

In the embodiments of the present disclosure, the terms ‘first’, ‘second’, etc. are used to distinguish different elements from appellations, but they do not indicate any spatial arrangement or temporal order of the elements, and the elements should not be limited by the terms. The term ‘and/or’ includes any one and all combinations of one or more of the associated listed terms. The terms ‘include’, ‘comprise’, ‘have’, etc. refer to the presence of stated features, elements, parts or components, but do not exclude the presence or addition of one or more other features, elements, parts or components.

In the embodiments of the present disclosure, singular forms such as ‘a’ and ‘the’ include plural forms, which should be broadly understood as ‘a kind of’ or ‘a category of’ rather than being limited to the meaning of ‘one’. Further, the term ‘the’ should be understood to include both singular and plural forms, unless the context clearly indicates otherwise. In addition, the term “according to” should be understood as ‘at least partially according to . . . ’, and the term ‘based on’ should be understood as ‘at least partially based on . . . ’, unless the context clearly indicates otherwise.

### Embodiments of A First Aspect

An embodiment of a first aspect of the present disclosure provides a charging control pilot circuit 1.

FIG. 1 is a schematic diagram of a charging control pilot circuit 1 according to an embodiment of a first aspect of the present disclosure. As illustrated in FIG. 1, the charging control pilot circuit 1 may include a lead group 11, a first loop 12 and a second loop 13.

The lead group 11 may include a first lead 111, a second lead 112, and a third lead 113. In this embodiment, one end A1 of the first lead 111, one end A2 of the second lead 112 and one end A3 of the third lead 113 are respectively electrically connected to a connection line of an external charging device.

The first loop 12 may include two or more resistors corresponding to the type of the external charging device. The first loop 12 is disposed between the other end B1 of the first lead 111 and the other end B3 of the third lead 113, and is electrically connected to the first lead 111 and the third lead 113.

The second loop 13 is disposed between the other end B2 of the second lead 112 and the other end B3 of the third lead 113, and is electrically connected to the second lead 112 and the third lead 113.

In the embodiment of the present disclosure, by disposing a plurality of resistors corresponding to the type of the charging device in the charging control pilot circuit 1, an electric vehicle may be forwardly compatible with a plurality of charging systems, and meet the demand of the current charging market.

In one or more embodiments, the charge control pilot circuit 1 may be applied to an electric vehicle. In this embodiment, the electric vehicle may be any type of electric vehicle, such as a battery electric vehicle or a hybrid electric vehicle. For another example, the electric vehicle may be an electric vehicle with the ChaoJi charging system or an electric vehicle based on other standards.

In one or more embodiments, the first loop 12 includes two or more resistors with resistance values corresponding to different external charging devices, respectively. The external charging device may be, for example, at least one of the following four types of external charging devices: a charging device of the ChaoJi charging system (hereinafter referred to as a ChaoJi charging device), a charging device of the GB2015 charging system (hereinafter referred to as a GB2015 charging device), a charging device of the CHAdeMO charging system (hereinafter referred to as a CHAdeMO charging device), and a charging device of the CCS charging system (hereinafter referred to as a CCS charging device), in which the CCS charging device may be classified into a charging device of a CCS1 charging system (hereinafter referred to as a CCS1 charging device) and a charging device of a CCS2 charging system (hereinafter referred to as a CCS2 charging device). However, the present disclosure is not limited thereto, and the first loop 12 may further include resistors corresponding to other standards, so that the electric vehicle can be forwardly compatible with other charging systems.

In one or more embodiments, as illustrated in FIG. 1, the first loop 12 may include a first branch 121. The first branch 121 includes a first resistor R4, a second resistor R4c, a third resistor R4c′ and a single-pole four-throw switch S2. A moving contact of the single-pole four-throw switch S2 is connected to the other end B1 of the first lead 111; the four static contacts of the single-pole four-throw switch S2 are respectively suspended and connected to the first resistor R4, the second resistor R4c and the third resistor R4c′; and the first resistor R4, the second resistor R4c and the third resistor R4c′ are connected to the other end B3 of the third lead 113.

In one or more embodiments, the resistance values of the first resistor R4, the second resistor R4c and the third resistor R4c′ are greater than 0 and less than or equal to 100 MΩ respectively.

In one or more embodiments, as illustrated in FIG. 1, the resistance value of the first resistor R4 is greater than that of the third resistor R4c′, and the resistance value of the third resistor R4c′ is greater than that of the second resistor R4c. However, the present disclosure is not limited thereto, and the resistance values of the first resistor R4, the second resistor R4c and the third resistor R4c′ may also satisfy other relationships.

In one or more embodiments, as illustrated in FIG. 1, the resistance value of the first resistor R4 is 10 times that of the second resistor R4c′. However, the present disclosure is not limited thereto, and the resistance values of the first resistor R4 and the second resistor R4c may also satisfy other relationships.

In one or more embodiments, as illustrated in FIG. 1, the resistance value of the first resistor R4 may be 1.3 kΩ, the resistance value of the second resistor R4c may be 130Ω, and the resistance value of the third resistor R4c′ may be 830Ω. In other words, the first resistor R4 may be a resistor corresponding to the ChaoJi charging device and/or the CCS charging device, the second resistor R4c may be a resistor corresponding to the CHAdeMO charging device, and the third resistor R4c′ may be a resistor corresponding to the GB2015 charging device. Therefore, the electric vehicle can be simultaneously compatible with the ChaoJi charging system, the CCS charging system, the CHAdeMO charging system and the GB2015 charging system.

In one or more embodiments, an initial state of the single-pole four-throw switch S2 may be normally open, but the present disclosure is not limited thereto, and the initial state of the single-pole four-throw switch S2 may also be normally closed.

In one or more embodiments, as illustrated in FIG. 1, the first loop 12 may further include a second branch 122. The second branch 122 is connected in parallel with the first branch 121. The second branch 122 includes a first switch S2′ and a fourth resistor R4′ connected in series.

In one or more embodiments, a resistance value of the fourth resistor R4′ may be 2.74 kΩ. However, the present disclosure is not limited thereto, and the resistance value of the fourth resistor R4′ may also be any other value.

In one or more embodiments, an initial state of the first switch S2′ may be normally open, but the present disclosure is not limited thereto, and the initial state of the first switch S2′ may also be normally closed.

In one or more embodiments, as illustrated in FIG. 1, the first loop 12 may further include a third branch 123. The third branch 123 is connected in parallel with the first branch 121 and includes a fifth resistor R3′.

In one or more embodiments, a resistance value of the fifth resistor R3′ is 100 kΩ. However, the present disclosure is not limited thereto, and the resistance value of the fifth resistor R3′ may also be any other value.

In one or more embodiments, as illustrated in FIG. 1, the first loop 12 may further include a diode D1. A cathode of the diode D1 is connected to the moving contact of the single-pole four-throw switch S2, and an anode of the diode D1 is connected to the other end B1 of the first lead 111.

In one or more embodiments, as illustrated in FIG. 1, the second loop 13 may include a second switch Sv, a sixth resistor Rv, a power supply U2, a third switch Sv′ and a seventh resistor Rv′. The second switch Sv, the sixth resistor Rv and the power supply U2 are connected in series, and the sixth resistor Rv is connected in parallel with the seventh resistor Rv′ and the third switch Sv′.

In one or more embodiments, an output voltage of the power supply U2 may be 12V, a resistance value of the seventh resistor Rv′ may be 1.59 kΩ, and a resistance value of the sixth resistor Rv may be 1 kΩ.

In one or more embodiments, initial states of the second switch Sv and the third switch Sv′ may be normally open, but the present disclosure is not limited thereto, and the initial states of the second switch Sv and the third switch Sv′ may also be normally closed.

In one or more embodiments, a detection point 3 (such as DP3 illustrated in FIG. 1) may be disposed on the second loop 13. In this embodiment, by detecting a voltage at the detection point 3, a voltage on the second lead 112 may be obtained to determine the type of the external charging device, and a corresponding communication protocol may be selected according to the type of the external charging device to carry out a charging process.

In one or more embodiments, a detection point 2 (such as DP2 illustrated in FIG. 1) may be disposed on the first loop 12. In this embodiment, by detecting a voltage of the detection point 2, a voltage on the first lead 111 may be obtained to judge whether the charging can be performed, and if so, a charging process is carried out.

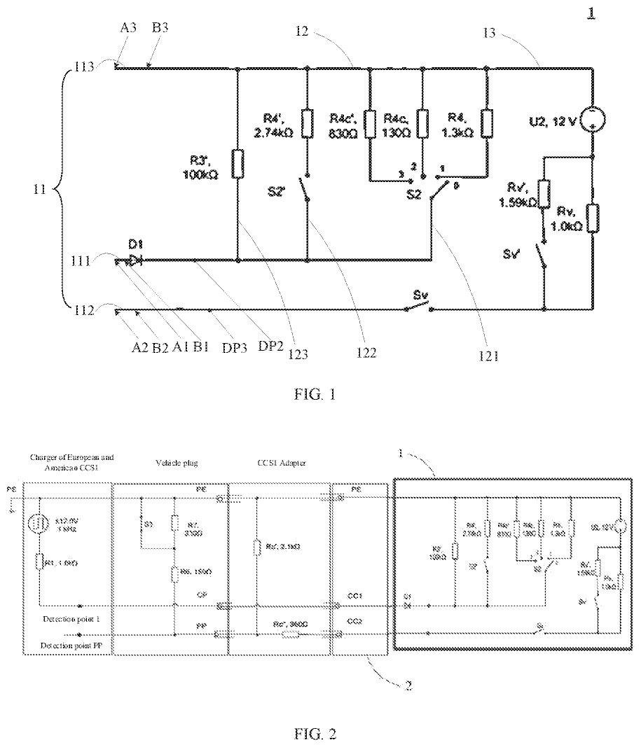

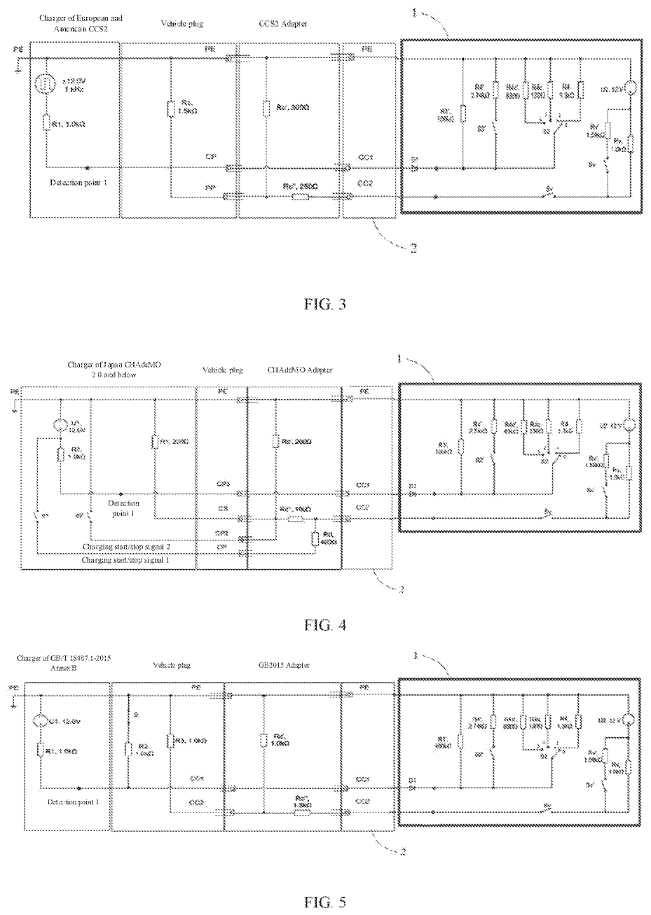

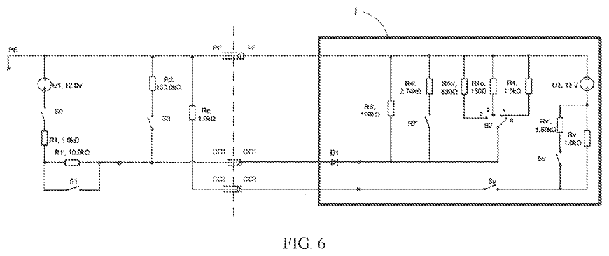

FIG. 2 is a schematic diagram of a connection between a charging control pilot circuit 1 and a CCS1 charging device, FIG. 3 is a schematic diagram of a connection between a charging control pilot circuit 1 and a CCS2 charging device, FIG. 4 is a schematic diagram of a connection between a charging control pilot circuit 1 and a CHAdeMO charging device, FIG. 5 is a schematic diagram of a connection between a charging control pilot circuit 1 and a GB2015 charging device, and FIG. 6 is a schematic diagram of a connection between a charging control pilot circuit 1 and a ChaoJi charging device.

In one or more embodiments, as illustrated in FIGS. 2 to 6, a CC1 lead of a charge control pilot circuit 1 may be corresponding to the first lead 111 of FIG. 1, a CC2 lead may be corresponding to the second lead 112 of FIG. 1, and a PE lead may be corresponding to the third lead 113 of FIG. 1.

In one or more embodiments, when the charging control pilot circuit 1 is electrically connected to an external charging device, the first lead 111, the second lead 112 and the third lead 113 are respectively connected to corresponding leads of the external charging device. For example, as illustrated in FIGS. 2 and 3, when the charge control pilot circuit 1 is connected to a CCS1 charging device or a CCS2 charging device, the CC1 lead, the CC2 lead and the PE lead of the charge control pilot circuit 1 are electrically connected to a CP lead, a PP lead and a PE lead of the CCS1 charging device or the CCS2 charging device, respectively.

In one or more embodiments, the charging control pilot circuit 1 may be electrically connected to the external charging device through a socket body. As illustrated in FIGS. 2 to 5, the charging control pilot circuit 1 may be electrically connected to the socket body 2, and the socket body 2 is electrically connected to the external charging device.

In one or more embodiments, the socket body 2 may be electrically connected to the external charging device through a corresponding adapter. As illustrated in FIGS. 2 to 5, the charging control pilot circuit 1 and the socket body 2 may be electrically connected to the CCS1 charging device, the CCS2 charging device, the CHAdeMO charging device and the GB2015 charging device through a CCS1 adapter, a CCS2 adapter, a CHAdeMO adapter and a GB2015 adapter, respectively.

In one or more embodiments, the electronic components, disposition positions, etc. in the charge control guide circuit 1 are not limited to FIGS. 1 to 6. For example, the charging control pilot circuit 1 may further include other electronic components not illustrated in the drawings, or the charging control pilot circuit 1 also may not include some electronic components illustrated in the drawings.

As can be seen from the above embodiments, by disposing a plurality of resistors corresponding to the types of the charging devices in the charging control pilot circuit, the electric vehicle can be forwardly compatible with a plurality of charging systems and meet the demand of the current charging market.

### Embodiments of A Second Aspect

An embodiment of the present disclosure further provides a charging socket, including a socket body and the charging control pilot circuit 1 as described in the embodiments of the first aspect, in which the socket body is electrically connected to the charging control pilot circuit 1, and the socket body may be the socket body 2 illustrated in FIGS. 2 to 6. By disposing a plurality of resistors corresponding to the types of the charging devices in the charging control pilot circuit, the electric vehicle can be forwardly compatible with a plurality of charging systems and meet the demand of the current charging market.

In the embodiments of the second aspect of the present disclosure, the structure of the above charging control pilot circuit may refer to the description of the embodiments of the first aspect, which will not be repeated here.

As can be seen from the above embodiments, by disposing a plurality of resistors corresponding to the types of the charging devices in the charging control pilot circuit, the electric vehicle can be forwardly compatible with a plurality of charging systems and meet the demand of the current charging market.

The present disclosure has been described as above in conjunction with the particular embodiments, but it should be clear to those skilled in the art that these descriptions are exemplary rather than limitations to the protection scope of the present disclosure. Those skilled in the art may make various variations and modifications to the present disclosure according to the spirits and principles of the present disclosure, and these variations and modifications are also within the scope of the present disclosure.

1. A charging control pilot circuit, comprising:
a lead group comprising a first lead, a second lead and a third lead, wherein one end of the first lead, one end of the second lead and one end of the third lead are respectively electrically connected to a connection line of an external charging device;
a first loop comprising two or more resistors corresponding to the type of the external charging device, wherein the first loop is disposed between the other end of the first lead and the other end of the third lead and electrically connected to the first lead and the third lead; and
a second loop disposed between the other end of the second lead and the other end of the third lead and electrically connected to the second lead and the third lead.

2. The charging control pilot circuit according to claim 1, wherein the first loop comprises a first branch, and the first branch comprises a first resistor, a second resistor, a third resistor and a single-pole four-throw switch, wherein a moving contact of the single-pole four-throw switch is connected to the other end of the first lead, and four static contacts of the single-pole four-throw switch are respectively suspended and connected to the first resistor, the second resistor and the third resistor, and the first resistor, the second resistor and the third resistor are connected to the other end of the third lead.

3. The charge control pilot circuit according to claim 2, wherein resistance values of the first resistor, the second resistor and the third resistor are respectively greater than 0 and less than or equal to 100 MΩ.

4. The charge control pilot circuit according to claim 2, wherein the first loop further comprises a second branch, which is connected in parallel with the first branch and comprises a first switch and a fourth resistor connected in series.

5. The charging control pilot circuit according to claim 4, wherein an initial state of the first switch is normally open.

6. The charging control pilot circuit according to claim 4, wherein an initial state of the first switch is normally closed.

7. The charge control pilot circuit according to claim 2, wherein the first loop further comprises a third branch, which is connected in parallel with the first branch and comprises a fifth resistor.

8. The charging control pilot circuit according to claim 2, wherein the first loop further comprises a diode, a cathode of which is connected to the moving contact of the single-pole four-throw switch, and an anode of which is connected to the other end of the first lead.

9. The charging control pilot circuit according to claim 2, wherein an initial state of the single-pole four-throw switch is normally open.

10. The charging control pilot circuit according to claim 2, wherein an initial state of the single-pole four-throw switch is normally closed.

11. The charge control pilot circuit according to claim 1, wherein the second loop comprises a second switch, a sixth resistor, a power supply, a third switch and a seventh resistor, wherein the second switch, the sixth resistor and the power supply are connected in series, and the sixth resistor is connected in parallel with the seventh resistor and the third switch.

12. The charging control pilot circuit according to claim 11, wherein initial states of the second switch and the third switch are normally open.

13. The charging control pilot circuit according to claim 11, wherein initial states of the second switch and the third switch are normally closed.

14. A charging socket, comprising the charging control pilot circuit according to claim.
